(19) United States
(12) Patent Application Publication
(10) Pub. No.: US 2017/0136971 A1
(43) Pub. Date: May 18, 2017

(54) BUMPER REINFORCEMENT

(71) Applicant: TOYODA IRON WORKS CO., LTD., Toyota-shi (JP)

(72) Inventor: Michio SUZUMORI, Toyota-shi (JP)

(73) Assignee: TOYODA IRON WORKS CO., LTD., Toyota-shi (JP)

(21) Appl. No.: 15/348,219

(22) Filed: Nov. 10, 2016

(30) Foreign Application Priority Data
Nov. 13, 2015 (JP) 2015-222844

(51) Int. Cl. B60R 19/44; B60R 19/02

(52) U.S. Cl. CPC B60R 19/44; B60R 19/023

(57) ABSTRACT

Embodiments includes a bumper reinforcement for an automobile, including a length of channel-shaped body member and a closure member closing the open side of the body member, the body member and the closure member forming a closed structure, wherein the closure member provides an impact surface that receives impact in an event of a collision. The closure member may include a lateral edge being overlapped on an inner surface of an open-side edge of the body member, the overlapped lateral edge and open-side edge being welded to each other; a flange extending from the lateral edge outwardly beyond the open-side edge of the body member.

### INCORPORATION BY REFERENCE

This application claims priority to Japanese Patent Application No. 2015-222844, filed Nov. 13, 2015, which is incorporated herein by reference in their entirety for all purposes.

### FIELD OF THE INVENTION

Embodiments of the present invention relates to a bumper reinforcement, and in particular to a bumper reinforcement that is disposed in the front and/or rear of the automobile body and exhibits an increased energy absorption and increased resistance to impact in the event of a collision.

### DESCRIPTION OF RELATED ART

An automobile is provided with bumper structures in the front and rear of the body that receive impact in the event of a collision. The bumper structure typically includes a bumper reinforcement as the core member. The bumper reinforcement extends along the width of the automobile body, and is supported at its end sections by support members attached to the automobile body frame.

FIG. 13 schematically illustrates a conventional bumper reinforcement 114. The bumper reinforcement 114 includes a body member 120 and a closure member 122. The body member 120 as shown has an inverted hat-shaped cross section, the open side upward, with flanges 126 extending outwardly from the open-side edges of the body member. The closure member 122 closes the open side of the body member 120 to form a closed structure. The closure member 122 is spot welded at 128 to the flanges 126 of the body member 120.

As shown in FIG. 13, the upper side of the closure member 122 provides an impact surface onto which impact forces are exerted in the event of a collision. The performance of the bumper reinforcement 114 upon a collision can he evaluated using a three-point bending test as illustrated in FIG. 14. In the three-point bending test, the bumper reinforcement 114 is supported by two support structures 118 positioned where actual bumper support members would be attached, and then an impact force is applied with an impactor or loading device 136 to the upper surface in the center of the reinforcement.

As shown in FIG. 14, when the impact force is applied to the bumper reinforcement 114, the central portion of the bumper reinforcement 114 bears the impact while bending downward. To provide an increased resistance to the impact received by the bumper reinforcement 114, the bumper reinforcement 114 has a closed cross section to improve the strength.

As shown in FIG. 14, when the bumper reinforcement 114 is bent downward under the impact forces, the weld joints between the flanges 126 of the body member 120 and the closure member 122 will experience forces directed such as to exfoliate the weld joints as shown by the arrow in FIG. 13. This is because the plane of the weld joints is perpendicular to the direction of impact forces.

In general, a weld joint by spot welding has less strength to exfoliating forces than to shearing forces. Therefore, the conventional cross-sectional configuration as described above may allow exfoliation of the weld joints between the flanges 126 of the body member and the closure member 122, in which case the closed structure cannot sufficiently exhibit its strength.

Further, the conventional configuration of the closed structure of the bumper reinforcement 114 as described above may allow the sidewall portions 120b, 120c of the body member 120 to deform, resulting in a collapse of the closed structure, in which case the bumper reinforcement cannot ensure sufficient strength or sufficient energy absorption.

### SUMMARY OF THE INVENTION

The present invention, in one aspect, provides a bumper reinforcement including a length of channel-shaped body member with an open side, a bottom portion, and sidewall portions extending from the bottom portion to open-side edges. The bumper reinforcement further includes a closure member closing the open side of the body member, the body member and the closure member forming a closed structure, wherein the closure member provides an impact surface that receives impact in an event of a collision. The closure member includes a central portion and lateral edges, at least one of the lateral edges being overlapped on an inner surface of an open-side edge of the body member, the overlapped lateral edge and open-side edge being welded to each other. The closure member further includes a flange extending from the at least one lateral edge outwardly beyond the open-side edge of the body member and substantially parallel to the impact surface in the closure member.

In some embodiments, the bumper reinforcement is disposed in a front or a rear of an automobile body such that the bumper reinforcement extends in a width of the automobile and that the open side of the body member faces outward of the automobile.

In some embodiments, the flange is raised above the central portion of the closure member.

In some embodiments, a stiffener is disposed in the closed structure of the body member and the closure member, the stiffener including lateral portions projecting toward the sidewall portions of the body member, and the stiffener being joined to the bottom portion of the body member and to the closure member.

In some embodiments, the stiffener further includes a substantially planar top portion joined to a lower surface of the closure member and a substantially planar bottom portion joined to an upper surface of the bottom portion of the body member.

In some embodiments, the stiffener is composed of an upper and a lower stiffener half coupled to each other.

In some embodiments, the lateral portions of the stiffener are spaced with a clearance from the sidewall portions of the body member to allow for an inward deflection of the sidewall portions of the body member when the bumper reinforcement is subjected to the collision impact

In some embodiments, at least one of the central portion of the closure member and the bottom portion of the body member has an inward recess.

In some embodiments, the central portion of the closure member is substantially planar and extending in the plane of the open side of the body member. The closure member further includes transitional portions between the central portion and the lateral edges, the transitional portions being depressed toward the bottom portion of the body member.

### BRIEF DESCRIPTION OF THE DRAWINGS

FIG. 1 is a schematic illustration of bumper structures in an automobile body according to one embodiment

FIG. 2 is a perspective view from the left rear of a front bumper reinforcement according to one embodiment.

FIG. 3 shows a cross section at the central section of the bumper reinforcement according to one embodiment.

FIG. 4 shows a cross section at the end sections of the bumper reinforcement according to one embodiment.

FIG. 5 shows a modified cross section at the central section of the bumper reinforcement according to one embodiment.

FIG. 6 shows another modified cross section at the central section of the bumper reinforcement according to one embodiment.

FIG. 7 shows a cross section where impact forces acting on the bumper reinforcement of FIG. 3 in a three-point bending test illustrated in FIG. 14.

FIG. 8 is an illustration of cross-sectional deformation phases of a bumper reinforcement according to one embodiment.

FIG. 9 is an illustration of cross-sectional deformation phases of a bumper reinforcement with no flanges for comparison with FIG. 8.

FIG. 10 is a chart of load applied and energy absorption versus displacement for (A) a conventional structure of FIG. 13, (B) an embodiment of FIG. 5, and (C) an embodiment of FIG. 3.

FIG. 11 is a comparative chart of peak load efficiency for (A) a conventional structure of FIG. 13, (B) an embodiment of FIG. 5, and (C) an embodiment of FIG. 3.

FIG. 12 is a comparative chart of energy absorption efficiency for (A) a conventional structure of FIG. 13, (B) an embodiment of FIG. 5, and (C) an embodiment of FIG. 3.

FIG. 13 is a perspective view of a conventional bumper reinforcement.

FIG. 14 is an illustration of the three-point bending test.

### DETAILED DESCRIPTION OF THE INVENTION

Embodiments of the present invention will be described below with reference to the drawings.

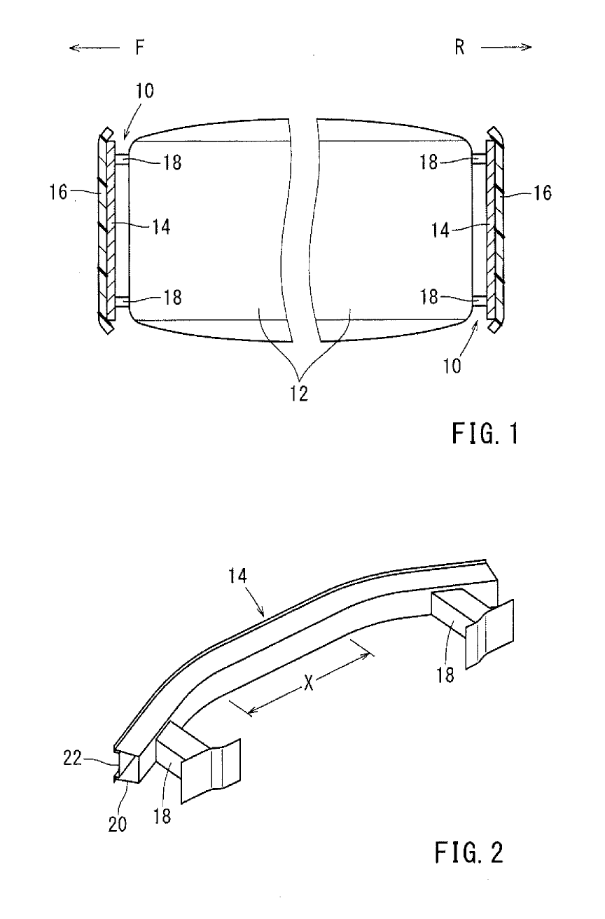

Referring to FIG. 1, the arrangement of the bumper structures 10 in an automobile is shown. The bumper structure 10 is typically disposed in the front and rear of the automobile body 12, and extends along the width of the automobile body 12. The automobile body 12 has a passenger compartment. In FIG. 1, the front side of the automobile body 12 is indicated by arrow F, and the rear side by arrow R. The bumper structure 10 may include a bumper reinforcement 14, a bumper cover 16, and bumper support members 18. The bumper reinforcement 14 functions as a core member that provides strength for the bumper structure 10. The bumper cover 16 covers the front side of the bumper reinforcement 14. The bumper cover 16 is disposed outermost of the bumper structure 10 and designed chiefly in consideration of appearance. The bumper cover is typically made of plastic or polymer suitable for implementation of desired exterior designs.

The bumper support members 18 are disposed between the frame members (not shown) of the automobile body 12 and the bumper reinforcement 14 and located at the end sections of the bumper reinforcement 14. The collision impact forces received by the bumper reinforcement 14 is then transferred through the bumper support members 18 to the automobile body 12, and finally borne by the automobile body 12. The bumper reinforcement 14 may be described in embodiments below as disposed in the front of the automobile body 12 for convenience. In other embodiments, however, the bumper reinforcement 14 may be disposed in the rear of the automobile body.

In the front bumper structure configured as described above, the impact on the center of the bumper structure 10 upon a frontal collision is first received by the bumper cover 16, and then transferred to the bumper reinforcement 14. The impact forces experienced by the bumper reinforcement 14 are then transferred through the bumper support members 18 at the end sections of the bumper reinforcement 14 to the automobile body 12. FIG. 2 shows an arrangement of the bumper reinforcement 14 and the bumper support members 18 as viewed obliquely from the left rear.

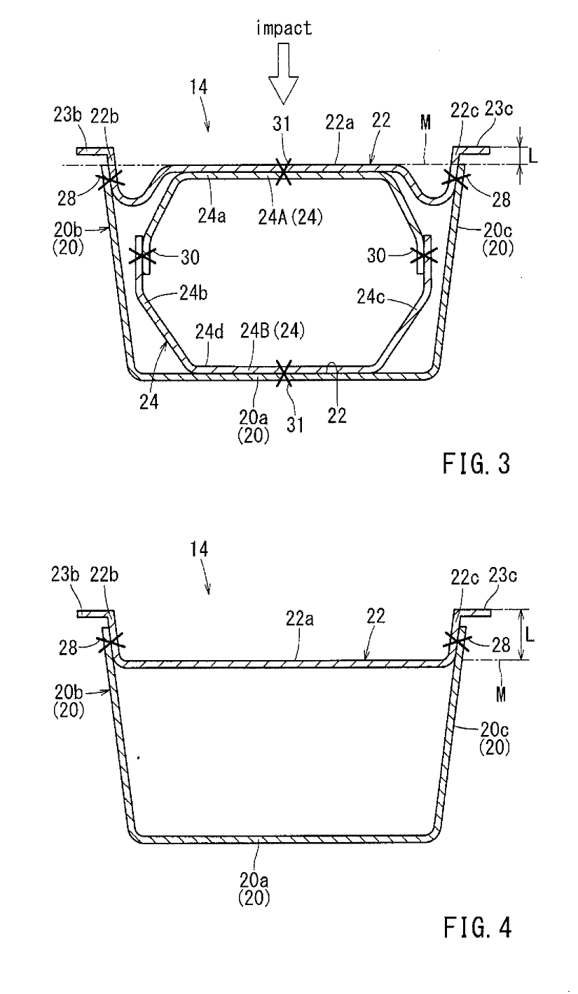

FIG. 3 shows a cross-sectional configuration of the bumper reinforcement 14 at a location within a length X in the central section. FIG. 4 shows a cross-sectional configuration of the bumper reinforcement 14 at another location in the end sections other than the length X.

Referring to FIG. 3, in one embodiment, the bumper reinforcement 14 generally composed of a body member 20, a closure member 22, and a stiffener 24 of a length X in the central section. These members 20, 22 and 24 are typically made of steel.

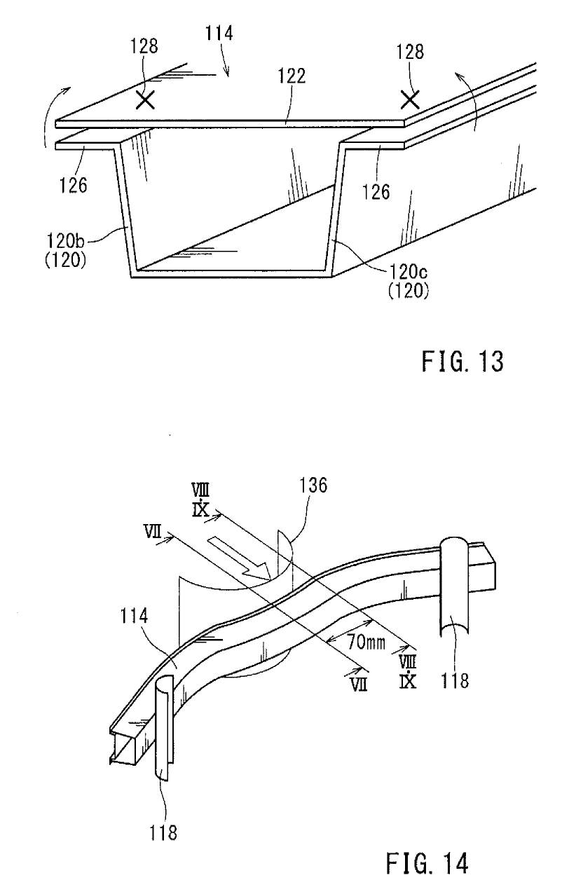

The body member 20 may be a length of channel-shaped member or beam, disposed such that the open side of the channel-shaped body member faces outward of the automobile body 12, i.e. towards the far side from the passenger compartment. FIG. 3 depicts the outward side up. The term “channel” as used here with respect to the shape of the body member 20 implies the absence of any flanges (such as the flanges 126 in the conventional structure shown in FIG. 13) extending outwardly from the open-side edges.

The closure member 22 closes the open side of the channel-shaped body member 20, and provides an impact surface that receives impact forces in the event of a collision. The closure member 22 is a length of flat sheet or strip adapted to close substantially all of the open side of the channel-shaped body member 20. The closure member 22 is joined to the body member 20 with the lateral edges 22b, 22c of the closure member 22 overlapped on the inner surfaces of the open-side edges of the sidewall portions 20b, 20c of the body member 20. In one embodiment, the closure member 22 may have transitional gutter portions between the lateral edges 22b, 22c and the central portion 22a that are depressed toward the bottom portion 20a of the body member 20. In one embodiment, the central portion 22a of the width (horizontal dimension in FIG. 3) of the closure member 22 defines a planar surface in the plane joining the open-side edges of the channel-shaped body member 20. In the figure, the dashed line M represents the plane of the impact surface in the central portion 22a of the closure member 22.

As shown in FIG. 3, the lateral edges 22b, 22c of the closure member 22 is joined to the sidewall portions 20b, 20c of the body member 20 through welding at 28. In the figures, the weld locations are indicated by cross symbols. In various embodiments, the method used for the weld joints described above and below may be any suitable welding process, including spot welding, arc welding, and laser welding. The plane of the joint surfaces of the sidewall portions 20b, 20c of the body member 20 and the lateral edges 22b, 22c of the closure member 22 may extend parallel to the direction of the impact forces acting on the closure member 22 so that the impact forces act on the spot welds 28 as shearing forces.

The closure member 22 includes flanges 23b, 23c extending from the lateral edges 22b, 22c. The flanges 23b, 23c extend outwardly beyond the open-side edges of the body member 20, and may extend generally parallel to the surface plane of the closure member 22 indicated by line M mentioned above. In other embodiments, only one of the lateral edges 22b, 22c may have a flange, although the flanges 23b, 23c on both lateral edges 22b, 22c are more advantageous. In one embodiment, as shown in FIG. 3, the flanges 23b, 23c may be raised a distance L above the impact surface (line M) in the central portion 22a of the closure member 22. The flanges are raised in the opposite direction to the collision impact forces. This configuration allows the impact forces to earlier act onto the flanges 23b, 23c of the body member 20, causing the sidewall portions 20b, 20c to deform inwardly. In other embodiments, the flanges 23b, 23c may not be raised as described above, although the raised flanges are more advantageous.

As shown in FIG. 3, the stiffener 24 is disposed in a closed structure formed by the body member 20 and the closure member 22. In one embodiment, the stiffener 24 may be composed of two halves, an upper stiffener half 24A and a lower stiffener half 24B, joined together with their edges overlapped and welded at 30. In other embodiments, the stiffener halves 24A and 24B may be welded with the edges of the halves 24A and 24B in abutment with each other. The upper stiffener half 24A and the lower stiffener half 24B may have the same cross section to allow for common use to reduce manufacturing cost. In other embodiments, The stiffener halves 24A and 24B may have different shapes without allowing for common use. In yet other embodiments, the stiffener 24 may be a single piece material formed into a desired (e.g. generally rhombic) shape described later.

As shown in FIG. 3, the stiffener 24 may generally consist of an top portion 24a, lateral portions 24b, 24c, and a bottom portion 24d, forming a tubular structure with a generally rhombic, or squashed hexagonal or octagonal cross section. The top portion 24a is placed against the lower surface of the central portion 22a of the closure member 22, and joined thereto by laser welding 31. The bottom portion 24d is placed against the upper surface of the bottom portion 20a of the body member 20, and is joined thereto by laser welding 31. The lateral portions 24b, 24c are each in an angled configuration projecting toward the respective sidewall portions 20b, 20c of the body member 20. The projecting lateral portions 24b, 24c of the stiffener 24 are spaced with a clearance from the sidewall portions 20b, 20c of the body member 20. This clearance facilitates inward deformation of the sidewall portions 20b and 20c of the body member 20 due to an external impact when the sidewall portions 20b and 20c are deformed in order to minimize outward deformation of the sidewall portions 20b and 20c.

The stiffener 24 is secured to the outer closed structure of the body member 20 and the closure member 22 after the closed structure has been formed by welding at 28 the body member 20 and the closure member 22. Specifically, the tubular stiffener 24 is placed into the channel-shaped body member 20, and then the closure member 22 is welded at 28 to the body member 20 to enclose the stiffener 24 in the closed structure. The top portion 24a of the stiffener 24 is then joined to the central portion 22a of the closure member 22 by the laser welding 31 from outside of the closure member 22. The bottom portion 24d of the stiffener 24 is joined to the bottom portion 20a of the body member 20 by the laser welding 31 from the outside of the body member 20.

Referring now to FIG. 4, the cross-sectional configuration of the end sections of the bumper reinforcement 14 in FIG. 2 will be described. In the descriptions below, the features different from those shown in FIG. 3 will be focused on. Similar features to those in FIG. 3 are denoted with the same reference numerals and their detailed description are omitted. The cross-sectional configuration of the body member 20 may be the same as that shown in FIG. 3. The configuration of joint between the lateral edges 22b, 22c of the closure member 22 and the sidewall portions 20b, 20c of the body member 20 may also be the same as that in FIG. 3. However, the position of the central portion 422a of the closure member 22 is different from that shown in FIG. 3 in that the central portion 422a generally extends at the level of the lower ends of the lateral edges 22b, 22c of the closure member 22 as shown in FIG. 4, rather than being raised at the level of the plane (line M in FIG. 3) joining the open side edges of the body member 20. This positioning facilitates shaping the closure member 22. Since the end sections of the bumper reinforcement 14 is relatively unlikely to experience impact forces upon collision as compared to the central section, the cross-sectional area in the end sections can be made smaller than that in the central section as shown in FIG. 3. The inner stiffener 24 does not extend to the end sections of the bumper reinforcement 14. The cross section of the closure member 22 may be gradually varied from within the length X shown in FIG. 2 to the end sections, i.e. from the shape shown in FIG. 3 to the shape shown in FIG. 4. Alternatively, the cross section may be varied stepwise. In other embodiments, the stiffener 24 may not be confined in the central section of the bumper reinforcement 14, but may extend into the end sections as needed.

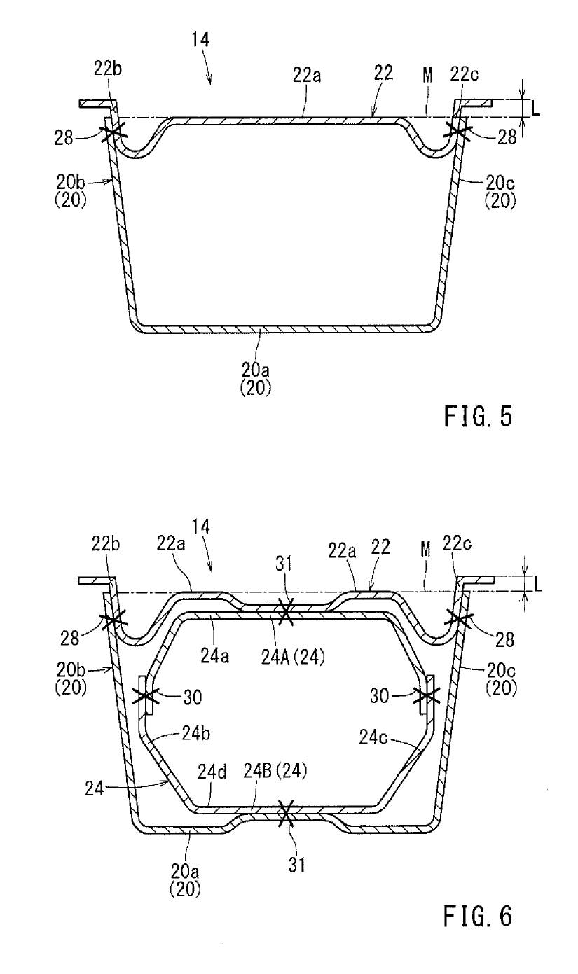

FIG. 5 shows a modified cross section of the bumper reinforcement 14 in an embodiment. This embodiment includes no stiffener in the closed structure. This configuration may be suitable when the body member 20 and the closure member 22 joined as described above can provide sufficient strength without any stiffener disposed in the closed structure. This configuration is simpler for the omitted stiffener and thus reduces the manufacturing cost.

FIG. 6 shows another modified cross section of the bumper reinforcement 14 in an embodiment. In this embodiment, the closure member 22 and the bottom portion 20a of the body member 20 each have a recess in the middle. The recesses provide contact area for welding at 31 of the closure member 22 and the body member 20 to the top portion 24a and bottom portion 24d of the stiffener 24. This configuration provides an improved strength of the bottom portion 20a of the closure member 22 and the body member 20. Again, in this modified embodiment, the stiffener 24 may not included, as in the embodiment of FIG. 5 described above.

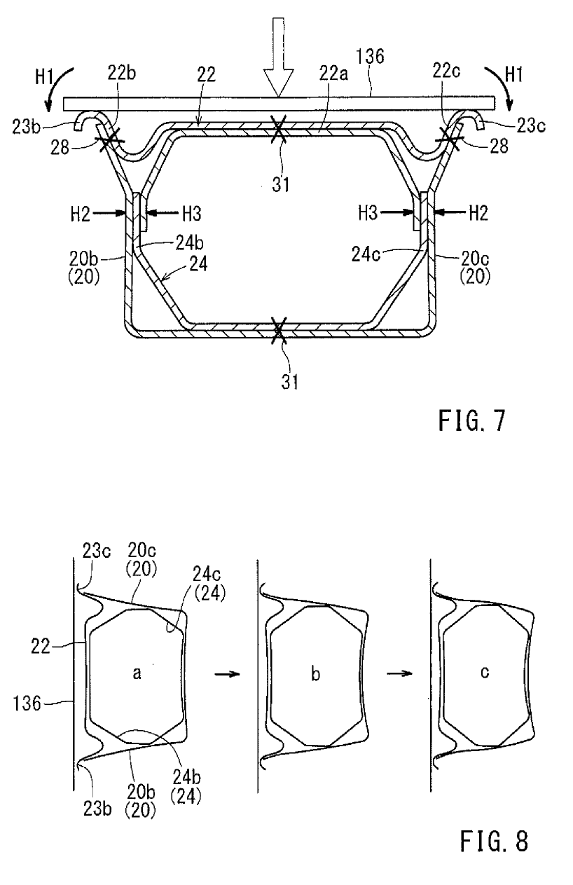

Referring now to FIG. 7, the operation of the embodiments as shown in FIGS. 2-4 in the event of frontal collision will be described. FIG. 7 shows the cross section of the bumper reinforcement 14 at the spot of impact (i.e. at line VII-VII of FIG. 14) in a three-point bending test as illustrated in FIG. 14, where the head of the impactor or loading device 136 contacts the bumper reinforcement 14.

The impactor 136 first hits the flanges 23b, 23c raised toward the impactor, causing the flanges 23b, 23c to deform in the direction of arrow H1. Subsequently, impact forces act onto the impact surface in the central portion 22a of the closure member 22. The forces acting on the flanges 23b, 23c and the impact surface of the closure member 22 is then exerted on the welds 28 joining the lateral edges 22b, 22c of the closure member 22 and the sidewall portions 20b, 20c of the body member 20. Since the plane of the joint surfaces is generally parallel to the direction of the impact forces, the spot welds 28 is subjected to shearing forces rather than exfoliating forces. The greater strength of the welds 28 against shearing forces ensures that the closure member 22 and the body member 20 can maintain the closed structure to bear the collision impact, resulting in an increased resistance to collision impact

In addition, the embodiments with a stiffener 24 in closed structure can bear the collision impact by the stiffener 24 as well as reduce the deformation (e.g. by budding) or collapse of the closed structure by the stiffener 24, and achieve an increased resistance to collision impact. For example, a collision impact may be applied to the impact surface in the central portion 22a of the closure member 22 as illustrated in FIG. 7. The lateral edges 22b and 22c of the closure member 22 and the sidewall portions 20b and 20c of the body member 20 at the spot welds 28 then leans outward as indicated by the arrows H1. This leaning deformation H1 induces an inward deflection of the sidewall portions 20b and 20c of the body member 20, that is, a deformation in their middle part toward the lateral portions 24b and 24c of the 11 inner stiffener 24, as indicated by the arrows H2. This inward deformation 112 closes the clearance between the body member 20 and the stiffener 24 until the sidewall portions 20b and 20c of the body member 20 butts against the lateral portions 24b and 24c of the stiffener 24. The lateral portions 24b and 24c of the stiffener 24 then generate a reaction force H3 to prevent or minimize the deformation of the sidewall portions of the body member. This process consequently prevent or minimize collapse of the sidewall portions 20b and 20c of the body member 20 before the bumper reinforcement bears a greater load.

In addition, the embodiments with a tubular stiffener 24 of a generally rhombic cross section with the top portion 24a laser welded at 31 to the closure member 22 and the bottom portion 24d laser welded at 31 to the bottom portion 20a of the body member 20 as described above can bear the collision impact in the entire tubular stiffener 24. The effects of the stiffener 24 described above may together lead to an increased resistance to collision impact and an increased energy absorption (EA).

In contrast to the conventional structure (as in FIG. 13) which has flanges 126 in the body member, embodiments of the present invention only have the flanges 23b, 23c on the lateral edges 22b, 22c of the closure member 22, with no flanges on the open-side edge of the body member 120, as shown in FIG. 3. Thereby the inward forces on the sidewall portions 20b, 20c of the body member 20 are effective even at a substantial distance (e.g. 70 mm) away from the spot of collision impact.

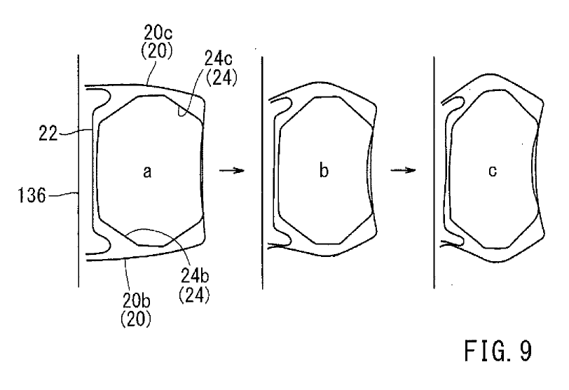

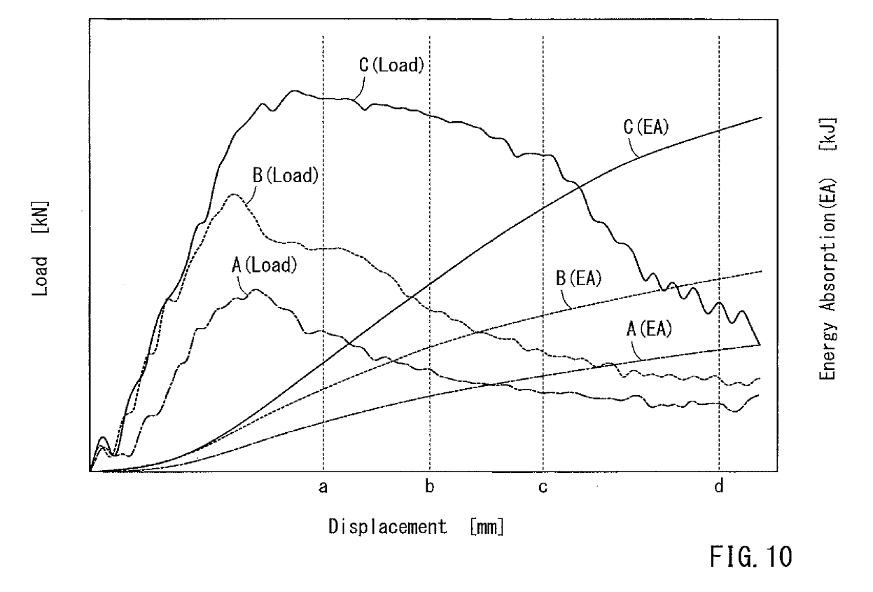

Referring to FIGS. 8 and 9, the effects of the flanges 23b, 23c mentioned above will be demonstrated. The figures show modes of deformation of the cross section at line VIII/IX-VIII/IX indicated in FIG. 14, with FIG. 8 representing an embodiment with the flanges 23b, 23c as shown in FIG. 3, and FIG. 9 an embodiment with the flanges 23b, 23c removed from FIG. 3. In each of FIGS. 8 and 9, three deformation phases labeled a, b and c respectively correspond to the displacement values a, b and c indicated in the chart of FIG. 10 discussed later. FIGS. 8 and 9 each show the progress of the deformation of the cross section of the bumper reinforcement 14 at a certain distance (70 mm in this simulation) from the spot of impact.

As can be seen in FIG. 9, in embodiments with no flanges, the sidewall portions 20b, 20c of the body member 20 bulge out after phase a, and further bulge out at phase c, reaching a cross-sectional collapse. In such embodiments, the bumper reinforcement cannot provide a sufficient resistance to collision impact or a sufficient energy absorption. It is noted that according to this simulation, no collapse in the cross section occurred at the very spot of impact in the bumper reinforcement 14 in the embodiment of FIG. 9, although this result is not shown. What is the problem here is that collapse occurs at a distance from that spot, as mentioned above.

As can be seen in contrast in FIG. 8, in the embodiment with flanges 23b, 23c only on the closure member 22 as shown in FIG. 3, there is little collapse at phases a and b, and thus the sidewall portions 20b, 20c of the body member 20 maintains their shape until phase c. The lack of cross-sectional collapse in such distant locations increases the resistance to collision impact and the energy absorption.

FIG. 10 is a comparative chart showing changes in the load applied to the bumper reinforcement and in the cumulative energy absorption (EA) in the bumper reinforcement versus the displacement of the impactor 136, which is obtained as the result of a three-point bending test as illustrated in FIG. 14 for three forms of bumper reinforcements A, B and C. In the chart of FIG. 10, A represents a conventional structure as shown in FIG. 13, B an embodiment according to FIG. 5, and C an embodiment according to FIG. 3. As can be seen well from the graphs for the three bumper reinforcements, the embodiments B and C both show increased load values at the peaks where buckling occurs, and particularly the embodiment C exhibits a noticeable increase. The energy absorptions for the embodiments B and C both significantly exceed that for the conventional structure A. In particular, the load graph for the embodiment C shows a wider peak, indicating a significant increase in the energy absorption. Further, the wider peak of the embodiment C rather than a sharp peak represents another advantage that the loading on the automobile body, which finally bear the collision impact, is reduced.

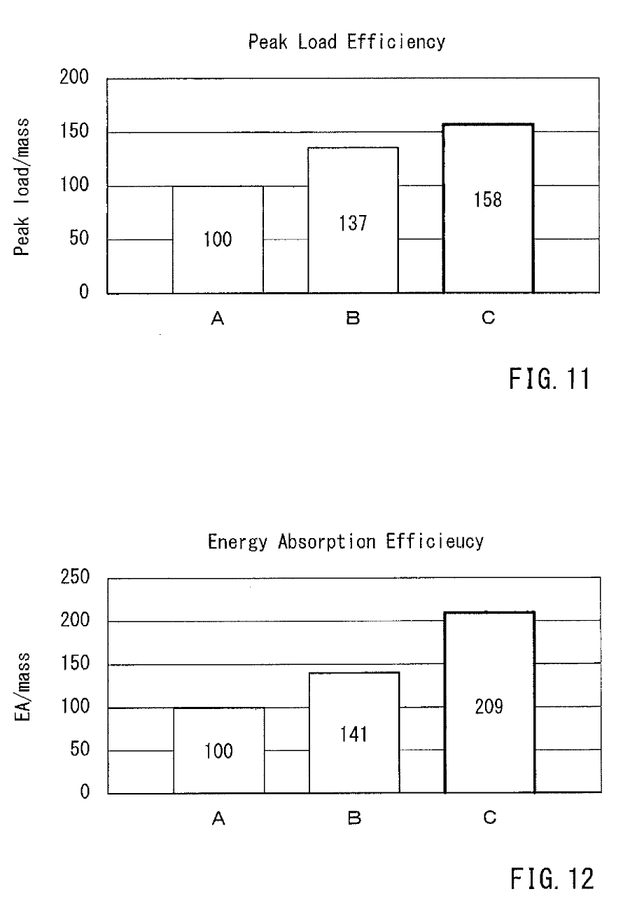

FIG. 11 shows a comparison of peak load efficiencies. The peak load efficiency is defined as the peak load divided by the mass of the bumper reinforcement. When the efficiency for the conventional structure A is taken as 100, then the embodiments B and C show higher efficiencies of 137 and 158, respectively.

FIG. 12 shows a comparison of energy absorption efficiencies. The energy absorption efficiency is defined as the energy absorption divided by the mass of the bumper reinforcement. When A (conventional structure) is taken as 100, then the embodiments B and C show higher efficiencies of 141 and 209, respectively. The energy absorption values in the chart have been obtained by integrating each graph from displacement of 0 to 150 mm, i.e. to the point d indicated in FIG. 10.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

1. A bumper reinforcement for an automobile, comprising:
a length of channel-shaped body member with an open side, a bottom portion, and sidewall portions extending from the bottom portion to open-side edges; and
a closure member closing the open side of the body member, the body member and the closure member forming a closed structure, wherein the closure member provides an impact surface that receives impact in an event of a collision, the closure member comprising:
a central portion;
lateral edges, at least one of the lateral edges being overlapped on an inner surface of the corresponding open-side edge of the body member, the overlapped lateral edge and open-side edge being welded to each other;
a flange extending from the at least one lateral edge outwardly beyond the open-side edge of the body member and substantially parallel to the impact surface in the closure member.

2. The bumper reinforcement of claim 1, wherein the bumper reinforcement is disposed in a front or a rear of an automobile body such that the bumper reinforcement extends in a width of the automobile and that the open side of the body member faces outward of the automobile.

3. The bumper reinforcement of claim 1, the flange being raised above the central portion of the closure member.

4. The bumper reinforcement of claim 1, further comprising a stiffener disposed in the closed structure of the body member and the closure member, the stiffener comprising lateral portions projecting toward the sidewall portions of the body member, and the stiffener being joined to the bottom portion of the body member and to the closure member.

5. The bumper reinforcement of claim 4, the stiffener further comprising a substantially planar top portion joined to a lower surface of the closure member and a substantially planar bottom portion joined to an upper surface of the bottom portion of the body member.

6. The bumper reinforcement of claim 4, the stiffener being composed of an upper and a lower stiffener half coupled to each other.

7. The bumper reinforcement of claim 4, the lateral portions of the stiffener being spaced with a clearance from the sidewall portions of the body member to allow for an inward deflection of the sidewall portions of the body member when the bumper reinforcement is subjected to the collision impact.

8. The bumper reinforcement of claim 1, at least one of the central portion of the closure member and the bottom portion of the body member having an inward recess.

9. The bumper reinforcement of claim 1, the central portion of the closure member being substantially planar and extending in the plane of the open side of the body member, and the closure member further comprising transitional portions between the central portion and the lateral edges, the transitional portions being depressed toward the bottom portion of the body member.
